(19) United States
(12) Patent Application Publication
(10) Pub. No.: US 2026/0043277 A1
(43) Pub. Date: Feb. 12, 2026

(54) PADLOCK ASSEMBLY

(71) Applicant: MASTER LOCK COMPANY LLC, Oak Creek, WI (US)

(72) Inventors: Zachary T. Nave, Oak Creek, WI (US); Eric Douglas Stanford, Milwaukee, WI (US); Cornelius Robert O'Rourke, Brookfield, WI (US); Chloe King, Milwaukee, WI (US)

(21) Appl. No.: 19/292,397

(22) Filed: Aug. 6, 2025

Related U.S. Application Data
(60) Provisional application No. 63/680,918, filed on Aug. 8, 2024.

(51) Int. Cl. E05B 67/24

(52) U.S. Cl. CPC E05B 67/24

(57) ABSTRACT

A padlock includes a lock body, a shackle, and a locking mechanism. The shackle includes first and second cylindrical shackle legs receivable in corresponding first and second shackle bores in the lock body. The locking mechanism is disposed in a central cavity of the lock body and is operable between a locked position securing the shackle in a retracted position and an unlocked position permitting movement of the shackle to an extended position. The first shackle leg includes a keyed shackle segment and the first shackle bore includes a keyed shackle bore segment that is aligned with the keyed shackle segment when the shackle is in the retracted position. The keyed shackle segment and the keyed shackle bore segment are shaped to block rotation of the first shackle leg within the first shackle bore when the shackle is in the retracted position.

### CROSS-REFERENCE TO RELATED APPLICATION

The present application claims priority to and all benefit of U.S. Provisional Patent Application Ser. No. 63/680,918, filed on Aug. 8, 2024, for PADLOCK ASSEMBLY, the disclosure of which is incorporated by reference in its entirety.

### BACKGROUND

Padlocks are used in a variety of applications, including, for example, with enclosures such as lockers, storage sheds, and various gates and doors. A typical padlock includes a generally rectangular lock body having a generally U-shaped shackle extending from one end and a keyway disposed on an opposite end. When a proper key is inserted in the keyway, a key cylinder within the lock body may be rotated to disengage a locking mechanism from the shackle, allowing the shackle to slide out of the lock body until a short leg of the shackle is fully removed or separated from the lock body, allowing removal of the lock from a hasp or other such portion of an enclosure to be locked.

### SUMMARY

In an exemplary embodiment of the present disclosure, a padlock includes a lock body, a shackle, and a locking mechanism. The lock body includes a stack of laminated plates defining first and second shackle bores and a central cavity between the first and second shackle bores. The shackle includes first and second cylindrical shackle legs receivable in the first and second shackle bores of the lock body. The shackle is moveable in an axial direction between a retracted position and an extended position, with at least one of the first and second shackle legs being withdrawn from the lock body in the extended position. The locking mechanism is disposed in the central cavity of the lock body and is operable between a locked position securing the shackle in the retracted position and an unlocked position permitting movement of the shackle to the extended position. The first shackle leg includes a keyed shackle segment and the first shackle bore includes a keyed shackle bore segment defined by at least one plate of the stack of laminated plates. The keyed shackle bore segment is aligned with the keyed shackle segment when the shackle is in the retracted position. The keyed shackle segment and the keyed shackle bore segment are shaped to block rotation of the first shackle leg within the first shackle bore when the shackle is in the retracted position.

In another exemplary embodiment of the present disclosure, a padlock includes a lock body including g a stack of laminated plates defining first and second shackle bores and a central cavity between the first and second shackle bores, a shackle having first and second cylindrical shackle legs receivable in the first and second shackle bores of the lock body, the shackle being moveable in an axial direction between a retracted position and an extended position, with at least one of the first and second shackle legs being withdrawn from the lock body in the extended position, and a locking mechanism disposed in the central cavity of the lock body, the locking mechanism being operable between a locked position securing the shackle in the retracted position and an unlocked position permitting movement of the shackle to the extended position. The first shackle leg includes a keyed shackle segment and the first shackle bore includes a keyed shackle bore segment defined by at least one plate of the stack of lamination plates, with the keyed shackle bore segment being aligned with the keyed shackle segment when the shackle is in the retracted position, wherein the keyed shackle segment and the keyed shackle bore segment are shaped to block rotation of the first shackle leg within the first shackle bore when the shackle is in the retracted position. The keyed shackle segment includes a rib portion extending radially outward from a cylindrical portion of the first shackle leg.

In another exemplary embodiment of the present disclosure, a padlock includes a lock body, a shackle having first and second shackle legs receivable in corresponding first and second shackle bores in the lock body and moveable in an axial direction between a retracted position and an extended position, and a locking mechanism disposed in a central cavity of the lock body. The locking mechanism includes a first locking member and an actuator rotatable within the central cavity between a locked position and an unlocked position and including a blocker portion aligned with the first locking member. When the actuator is in the locked position, the blocker portion holds the first locking member in locking engagement with a laterally inward facing socket in the first shackle leg, and when the actuator is in the unlocked position, the blocker portion permits the first locking member to disengage from the first shackle leg socket. The first shackle leg socket includes side wall portions configured to block rotation of the first shackle leg within the first shackle bore when the first locking member is in locking engagement with the first shackle leg socket.

In another exemplary embodiment of the present disclosure, a padlock includes a lock body, a shackle having first and second shackle legs receivable in corresponding first and second shackle bores in the lock body and moveable in an axial direction between a retracted position and an extended position, and a locking mechanism disposed in a central cavity of the lock body. The locking mechanism includes a first locking member and an actuator rotatable within the central cavity between a locked position and an unlocked position and including a blocker portion aligned with the first locking member. When the actuator is in the locked position, the blocker portion holds the first locking member in locking engagement with a laterally inward facing notch in the first shackle leg, and when the actuator is in the unlocked position, the blocker portion permits the first locking member to disengage from the first shackle leg notch. When the shackle is in a partially withdrawn position between the retracted position and the extended position, the first locking member is aligned and engaged with an axially extending, laterally inward facing concave surface of the first shackle leg.

### BRIEF DESCRIPTION OF THE DRAWINGS

Further features and advantages will become apparent from the following detailed description made with reference to the accompanying drawings, wherein:

FIG. 1 is a front perspective view of a padlock;

FIG. 2 is a front cross-sectional perspective view of the padlock of FIG. 1, shown in a locked condition;

FIG. 3 is a front cross-sectional perspective view of the padlock of FIG. 1, shown in an unlocked condition;

FIG. 4 is a schematic front-cross-sectional view of a padlock shown in a locked condition, according to an exemplary aspect of the present disclosure;

FIG. 5 is a schematic top cross-sectional view of the padlock of FIG. 4;

FIG. 5A is a schematic top cross-sectional view of another padlock, according to another exemplary aspect of the present disclosure;

FIG. 5B is a schematic top cross-sectional view of another padlock, according to another exemplary aspect of the present disclosure;

FIG. 6 is a front cross-sectional view of a padlock according to an exemplary aspect of the present disclosure, shown in a locked condition;

FIG. 7 is a front cross-sectional perspective partial view of the padlock of FIG. 6, with some of the lock body components removed to illustrate additional features of the padlock;

FIG. 8 is a lower perspective view of the padlock of FIG. 6;

FIG. 9 is a front cross-sectional perspective view of the padlock of FIG. 6, shown in an unlocked or open condition;

FIG. 10 is a front cross-sectional view of a padlock according to another exemplary aspect of the present disclosure, shown in a locked condition;

FIG. 11 is a perspective view of the shackle and locking members of the padlock of FIG. 10;

FIG. 12 is a perspective view of a shackle, according to an exemplary aspect of the present disclosure;

FIG. 13 is a front cross-sectional view of a padlock including the shackle of FIG. 12; and

FIG. 14 is a partial perspective view of the padlock of FIG. 13, with portions of the padlock shown in phantom to illustrate additional features of the padlock.

### DETAILED DESCRIPTION

This Detailed Description merely describes exemplary embodiments and is not intended to limit the scope of the claims in any way. Indeed, the invention as claimed is broader than and unlimited by the exemplary embodiments, and the terms used in the claims have their full ordinary meaning. For example, while the specific embodiments described herein relate to key operated padlocks, the features of the present application may additionally or alternatively be applied to other types of padlocks, including, for example, combination padlocks and electromechanically operated padlocks, and other types of portable locks, including, for example, cable locks, pin locks, and coupler locks.

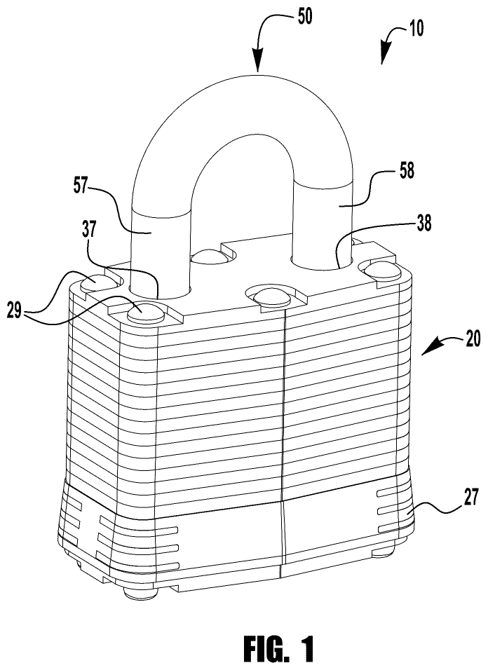

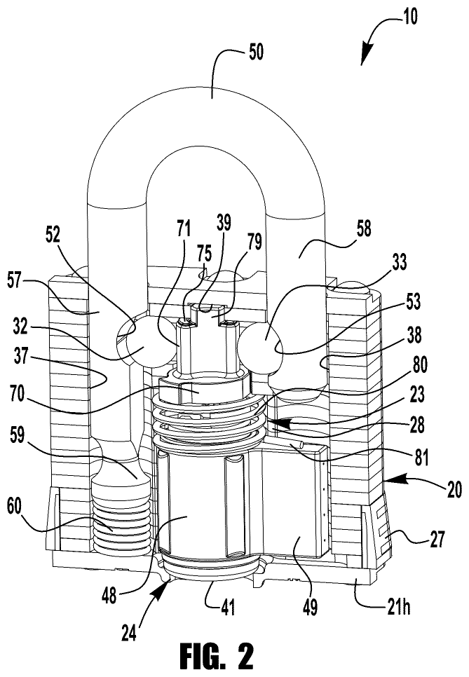

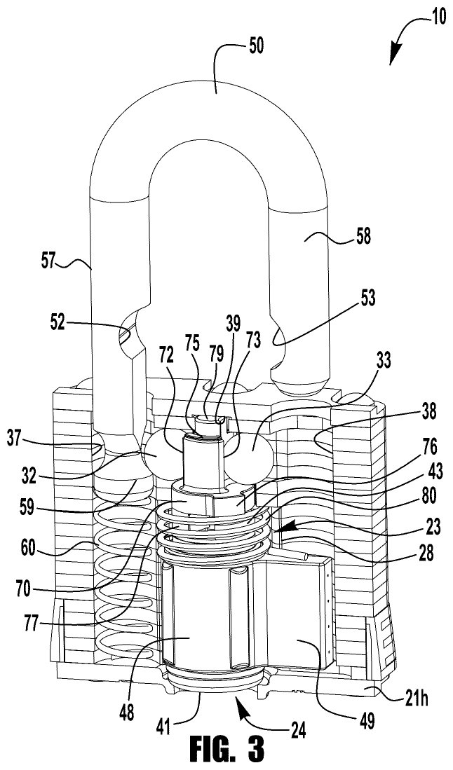

An exemplary padlock 10, illustrated in FIGS. 1-3, includes a lock body 20 with a first and second shackle bores 37, 38 extending from an upper end of the lock body and retaining first and second legs 57, 58 of a generally U-shaped shackle 50. A key cylinder lock 24 is disposed in a central cavity 23 in the lock body 20 (FIGS. 2 and 3), and includes a key operated plug 41 rotatable within a shell 48, using any suitable key cylinder locking arrangement, including wafer and pin tumbler locking arrangements, as known in the art. While the lock body may be formed from a variety of suitable constructions, in the illustrated embodiment, the lock body 20 is formed from a stack of laminated plates 21a-h, secured together by fasteners 29, and having cutouts arranged to form the shackle bores 37, 38 and central cavity 23. As shown, the key cylinder shell 48 may be provided with one or more ribs sized to provide press fit retention of the key cylinder shell within the central cavity 23. In other embodiments (not shown), a separate sleeve component may be assembled with the key cylinder shell to provide press fit retention. A soft (e.g., plastic, elastomeric) bumper sleeve 27 may be provided on a lower portion of the lock body 20.

An actuator 70 is disposed in the lock cavity 23 for co-rotation with the key cylinder plug 41, by interengagement of an upper extension 43 of the key cylinder plug with a lower extension 77 of the actuator. Upon insertion of an authorized key in the key cylinder plug keyway (not shown), rotation of the plug 41 rotates the actuator 70 between locked and unlocked positions. When the actuator 70 is in the locked position, as shown in FIG. 2, an outer surface 71 of a blocker portion 75 of the actuator 70 holds locking members 32, 33 (e.g., locking balls) in interlocking engagement with corresponding notches 52, 53 in the shackle legs 57, 58 to prevent withdrawal of the shackle 50 to the open position. When the key cylinder plug 41 and actuator 70 are rotated to the unlocked position, as shown in FIG. 3, recesses 72, 73 in the blocker portion 75 align with the locking members 32, 33 to allow the locking members to disengage or retract from the shackle notches 52, 53, and a compression spring 60 below the long shackle leg 57 biases the shackle 50 toward a withdrawn or open position, in which the short shackle leg 58 separates from the lock body 20. An end portion 59 of the long shackle leg 57 engages the retracted locking member 32 to prevent removal of the long shackle leg 57 from the lock body 20.

A helical coiled torsion spring 80 may apply an axial upward force to the actuator 70 to maintain axial alignment of the first engagement portion(s) or projections 76 of the actuator 70 with the second engagement portion(s) or cutouts 26 of the lock body 20, and to axially bias an upper portion of the actuator 70 (e.g., the projection(s) 76, or an uppermost end portion 79) into seated engagement with an upper lock body recess (e.g., the cutout(s) 26, or an uppermost recess 39) and against any movement out of axial alignment. A first end 81 of the spring 80 is received in a channel 28 between the central cavity and the short shackle bore 38 (and may be supported by a bible portion 49 of the key cy, and a second end 82 of the spring is received in the lower extension notch 78 of the actuator.

The illustrated exemplary padlock 10 is further shown and described in co-owned U.S. Pat. No. 10,221,592 (the “'592 Patent”), the entire disclosure of which is incorporated herein by reference.

A common method by thieves for defeating a padlock involves cutting through one of the shackle legs (e.g., using bolt cutters or other such tools) and applying a high twisting force to the U-bend portion of the shackle to rotate the uncut shackle leg, within the corresponding shackle bore, at least enough to produce a gap between the cut portions of the cut shackle leg to remove the shackle from the hasp or other padlock receiving element of a secured structure. The degree of shackle rotation within the shackle bore may depend, for example, on the looseness or play between the shackle notch and the locking ball, and/or deformation of the blocker material.

According to an exemplary aspect of the present disclosure, either or both of the shackle legs of a padlock may be provided with a keyed shackle segment that aligns with a keyed shackle bore segment in the corresponding shackle bore(s), with the keyed shackle segment(s) and the keyed shackle bore segment(s) being shaped to block or limit rotation of the corresponding shackle leg within the corresponding shackle bore when the shackle is in the retracted or closed position, for example, when the other shackle leg is cut and a twisting force is applied to the shackle U-bend and the corresponding (uncut) shackle leg. By “keyed,” it is meant that a first feature (e.g., the keyed shackle segment) fits with a second feature (e.g., the keyed shackle bore segment) so as to limit or prevent rotation of the first feature with respect to the second feature. In some embodiments, the interlocking engagement of the keyed shackle and shackle bore segments may limit rotation of the shackle leg within the shackle bore to less than about 26°, or less than about 13° in either direction from the non-twisted orientation, for example to ensure that the shackle leg cannot be rotated enough to provide a gap between the cut portions of the cut shackle leg, thereby preventing removal of the shackle from the hasp or other padlock receiving element of a secured structure.

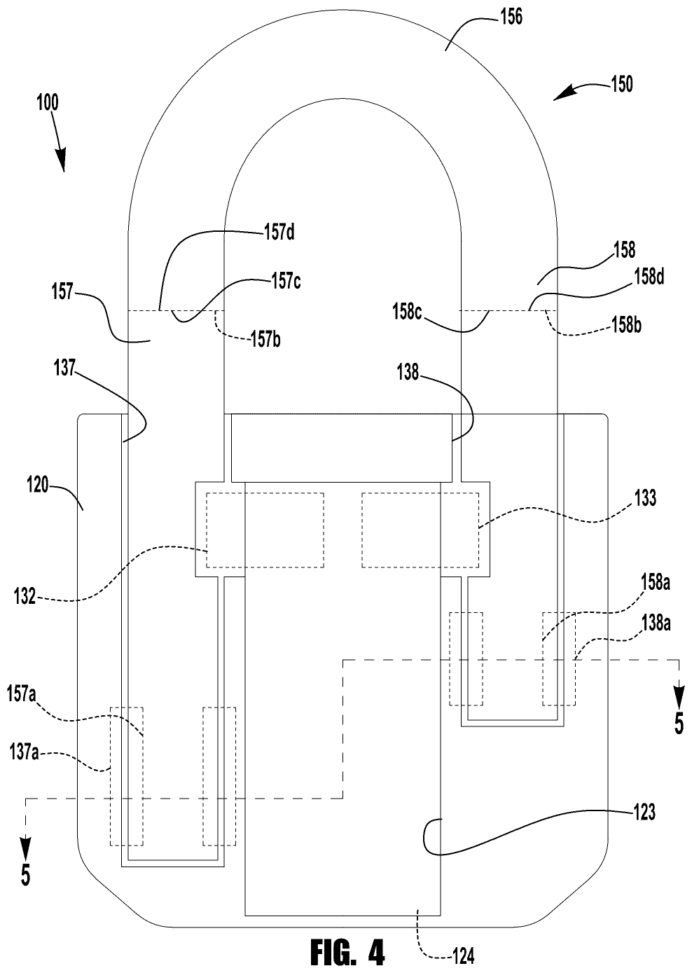

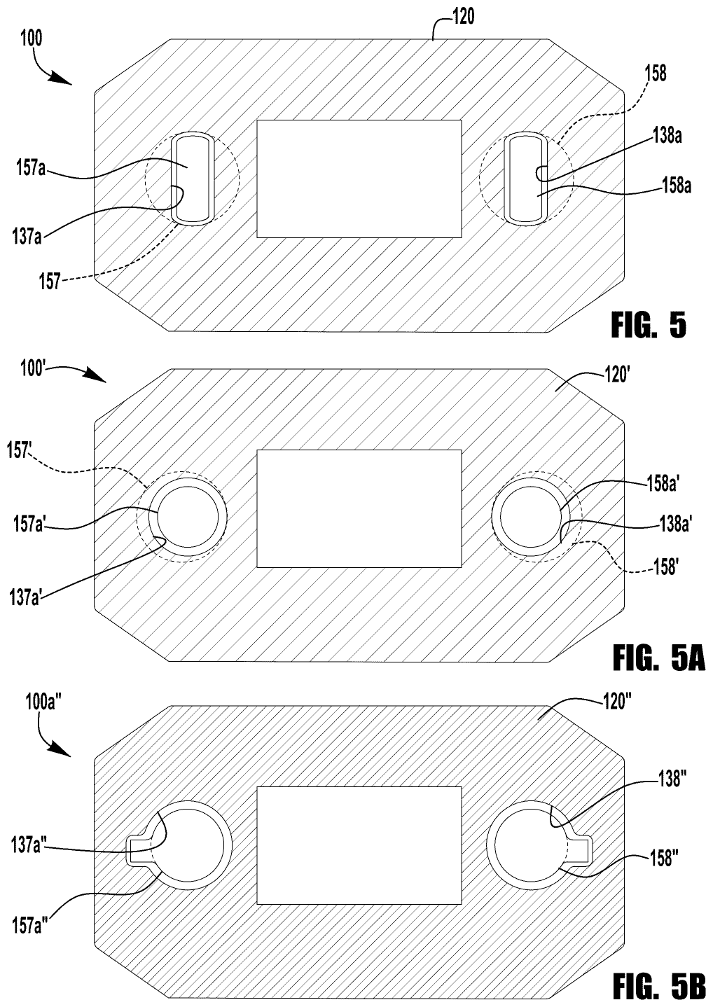

FIGS. 4 and 5 illustrate an exemplary padlock 100 in accordance with one or more exemplary aspects of the present disclosure. The exemplary padlock 100 includes a lock body 120 defining first and second shackle bores 137, 138 extending from an upper end 122 of the lock body and retaining generally cylindrical first and second legs 157, 158 of a generally U-shaped shackle 150. A locking mechanism 124 (e.g., key cylinder lock combination dial lock, etc.) is disposed in a central cavity 123 in the lock body and is operable to release a locking member 132, 133 from interlocking engagement with either or both of the shackle legs 157, 158 for movement of the shackle to the open or extended position.

In the illustrated embodiment, the first shackle leg 157 may include a keyed shackle segment 157a that aligns with a keyed shackle bore segment 137a of the first shackle bore 137 when the shackle 150 is in the closed or retracted position. In the event that the second shackle leg 158 is cut (e.g., at cut line 158b) and a twisting force is applied to the shackle U-bend 156 in an effort to improperly remove the padlock 100 from a secured structure, the keyed shackle segment 157a interlocks with the keyed shackle bore segment 137a to limit or prevent rotation of the first shackle leg 157 within the first shackle bore 137 to a degree that would prove a gap between the cut portions 158c, 158d of the second shackle leg 158 sufficient to remove the padlock from the secured structure.

Additionally or alternatively, the second shackle leg 158 may include a keyed shackle segment 158a that aligns with a keyed shackle bore segment 138a of the second shackle bore 138 when the shackle 150 is in the closed or retracted position. In the event that the first shackle leg 157 is cut (e.g., at cut line 157b) and a twisting force is applied to the shackle U-bend 156 in an effort to improperly remove the padlock 100 from a secured structure, the keyed shackle segment 158a interlocks with the keyed shackle bore segment 138a to limit or prevent rotation of the second shackle leg 158 within the second shackle bore 138 to a degree that would prove a gap between the cut portions 157c, 157d of the first shackle leg 157 sufficient to remove the padlock from the secured structure.

Many different types of keyed shackle and shackle bore segments may be utilized. For example, as shown in FIG. 5, either or both of the keyed shackle and shackle bore segments 157a, 158a, 137a, 138a may have complementary shaped non-circular cross-sections fitted to block or prevent rotation of the shackle leg when the keyed shackle segment is aligned with the keyed shackle bore segment. Additionally or alternatively, as shown in FIG. 5A, the keyed shackle and shack bore segments 157a′, 158a′, 137a′, 138a′ may have center points offset from the central axes of the shackle legs 157′, 158′ to block or prevent rotation of the shackle leg when the keyed shackle segment is aligned with the keyed shackle bore segment. In some embodiments, as shown in FIGS. 5 and 5A, the keyed shackle segment 157a, 157a′, 158a, 158a′ may be disposed at the endmost portion of the shackle legs 157, 157′, 158, 158′, and may be sized so as to be smaller than the generally cylindrical main portion of the shackle leg to allow for sliding movement of the keyed shackle segments through the non-keyed portions of the shackle bores 137, 137′, 138, 138′ when the shackle is withdrawn. In other embodiments, as shown in FIG. 5B, the upper portion of the corresponding shackle bore 137″, 138″ may be sized and/or shaped to accommodate a keyed shackle segment 157a″, 158a″ that includes a rib or tab portion extending radially outward from the generally cylindrical main portion of the shackle leg 157″, 158″.

While the illustrated example shows keyed shackle and shackle bore segments for both shackle legs, in some embodiments, only one shackle leg may be provided with a keyed interlocking arrangement with the corresponding shackle bore. For example, a padlock may include a locking arrangement that lockingly engages only one of the shackle legs (e.g., only the longer shackle leg or only the shorter shackle leg). In such an assembly, where the interlocking arrangement may be sufficient to restrict or prevent twisting rotation of the lockingly engaged shackle leg, keyed shackle and shackle bore segments may be provided for only the shackle leg that is not lockingly engaged by the locking mechanism.

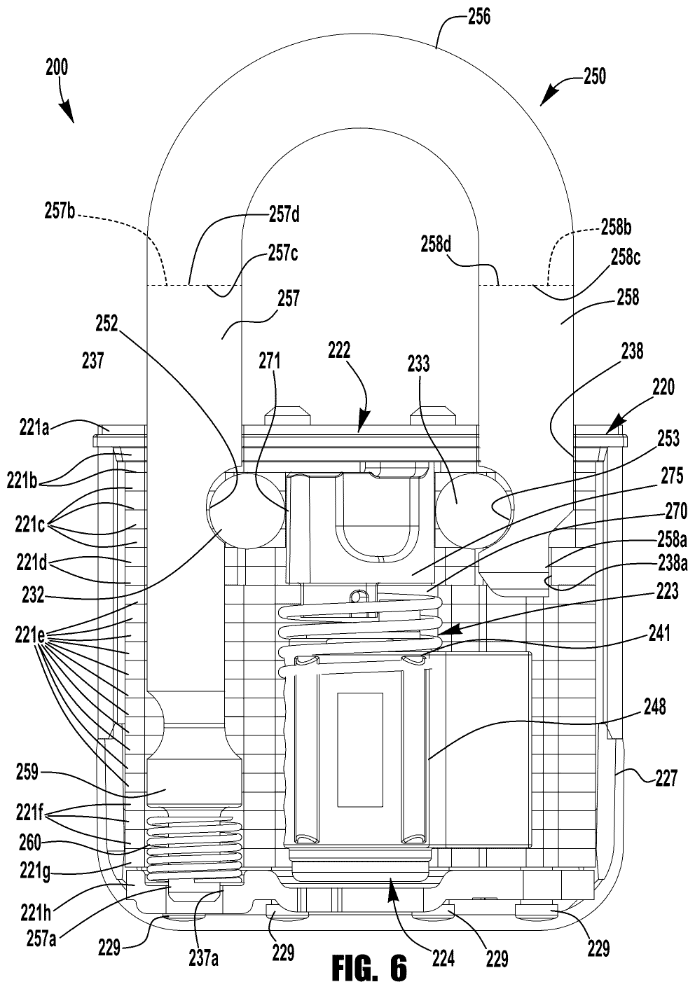

FIGS. 6-9 illustrate an exemplary padlock 200 in accordance with one or more exemplary aspects of the present disclosure. The exemplary padlock 200 includes a lock body 220 defining first and second shackle bores 237, 238 extending from an upper end 222 of the lock body and retaining generally cylindrical first and second legs 257, 258 of a generally U-shaped shackle 250. A key cylinder lock 224 is disposed in a central cavity 223 in the lock body 220 (FIGS. 4 and 5), and includes a key operated plug 241 rotatable within a shell 248, using any suitable key cylinder locking arrangement, including wafer and pin tumbler locking arrangements, as known in the art. While the lock body may be formed from a variety of suitable constructions, in the illustrated embodiment, the lock body 220 is formed from a stack of laminated plates 221a-h, secured together by fasteners 229 (e.g., rivets), and having cutouts arranged to form the shackle bores 237, 238 and central cavity 223. A soft (e.g., plastic, elastomeric) sleeve 227 may be provided on the lock body 220.

An actuator 270 is disposed in the lock cavity 223 for co-rotation with the key cylinder plug 241. Upon insertion of an authorized key in the key cylinder plug keyway (not shown), rotation of the plug 241 rotates the actuator 270 between locked and unlocked positions. When the actuator 270 is in the locked position, as shown in FIG. 6, an outer surface 271 of a blocker portion 275 of the actuator 270 holds locking members 232, 233 (e.g., locking balls) in interlocking engagement with corresponding notches 252, 253 in the shackle legs 257, 258 to prevent withdrawal of the shackle 250 to the withdrawn, extended, or open position.

In the illustrated embodiment, the first shackle leg 257 may include a keyed shackle segment 257a that aligns with a keyed shackle bore segment 237a of the first shackle bore 237 when the shackle 250 is in the closed or retracted position. In the event that the second shackle leg 258 is cut (e.g., at cut line 258b) and a twisting force is applied to the shackle U-bend 256 in an effort to improperly remove the padlock 200 from a secured structure, the keyed shackle segment 257a interlocks with the keyed shackle bore segment 237a to limit or prevent rotation of the first shackle leg 257 within the first shackle bore 237 to a degree that would prove a gap between the cut portions 258c, 258d of the second shackle leg 258 sufficient to remove the padlock from the secured structure.

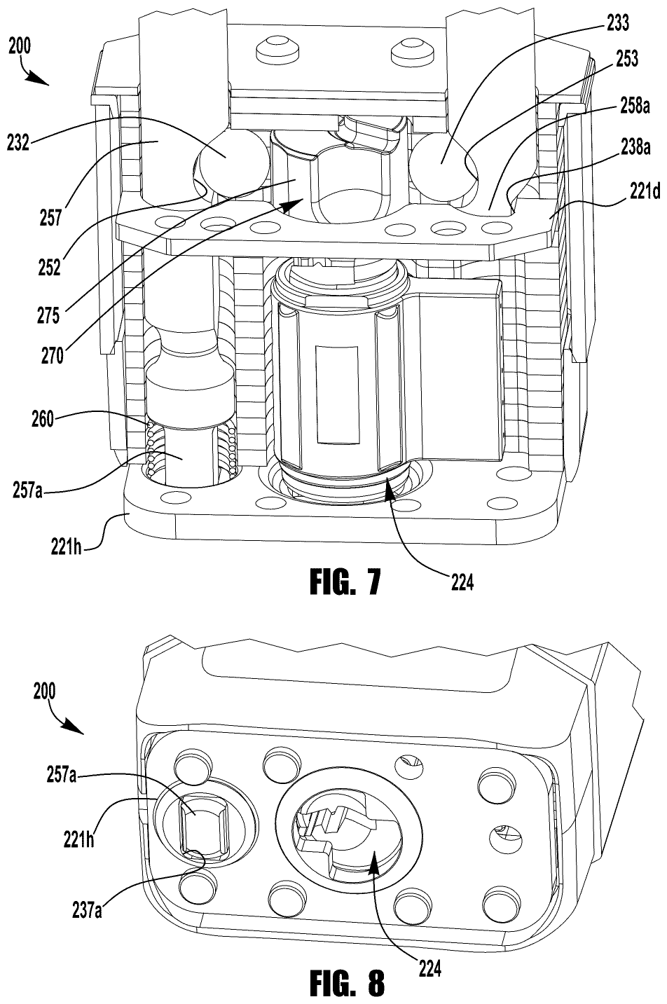

While many different types of keyed shackle and shackle bore segments may be utilized, in the illustrated embodiment, the keyed shackle segment 257a of the first shackle leg 257 is formed as a tab or post portion disposed at a terminal end or endmost portion of the first shackle leg. As shown in FIG. 7, the exemplary keyed shackle segment 257a and shackle bore segment 237a each have complementary shaped oblong (e.g., generally rectangular) cross-sections that rotationally interlock to prevent or limit rotation of the first shackle leg 257 within the first shackle bore 237. As shown in FIGS. 6 and 7, the keyed post portion 257a may be sized to extend through the shackle biasing spring 260 (described in greater detail below), and the keyed shackle bore segment 237a may be formed in the bottom most lock body plate 221h, against which the shackle biasing spring is seated. As shown in FIG. 8, the keyed shackle bore segment 237a may extend through the bottom most lock body plate 221h, such that the keyed shackle segment 257a is exposed to an exterior of the lock body 220 when the shackle 250 is in the closed or retracted position. In other embodiments (not shown), the keyed shackle segment may be covered by a bottom most portion of the lock body.

Additionally or alternatively, the second shackle leg 258 may include a keyed shackle segment 258a that aligns with a keyed shackle bore segment 238a of the second shackle bore 238 when the shackle 250 is in the closed or retracted position. In the event that the first shackle leg 257 is cut (e.g., at cut line 257b) and a twisting force is applied to the shackle U-bend 256 in an effort to improperly remove the padlock 200 from a secured structure, the keyed shackle segment 258a interlocks with the keyed shackle bore segment 238a to limit or prevent rotation of the second shackle leg 258 within the second shackle bore 238 to a degree that would prove a gap between the cut portions 257c, 257d of the first shackle leg 257 sufficient to remove the padlock from the secured structure.

While many different types of keyed shackle and shackle bore segments may be utilized, in the illustrated embodiment, the keyed shackle segment 258a of the second shackle leg 258 is formed as a notched or necked down portion disposed at a terminal end or endmost portion of the second shackle leg. As shown in FIG. 7, the exemplary keyed shackle segment 258a and shackle bore segment 238a each have complementary shaped semicircular cross-sections that rotationally interlock to prevent or limit rotation of the first shackle leg 258 within the first shackle bore 238. As shown in FIGS. 6 and 7, the keyed shackle bore segment 238a may be formed in the one or more of the laminated lock body plates 221d through which the keyed shackle segment 258a extends.

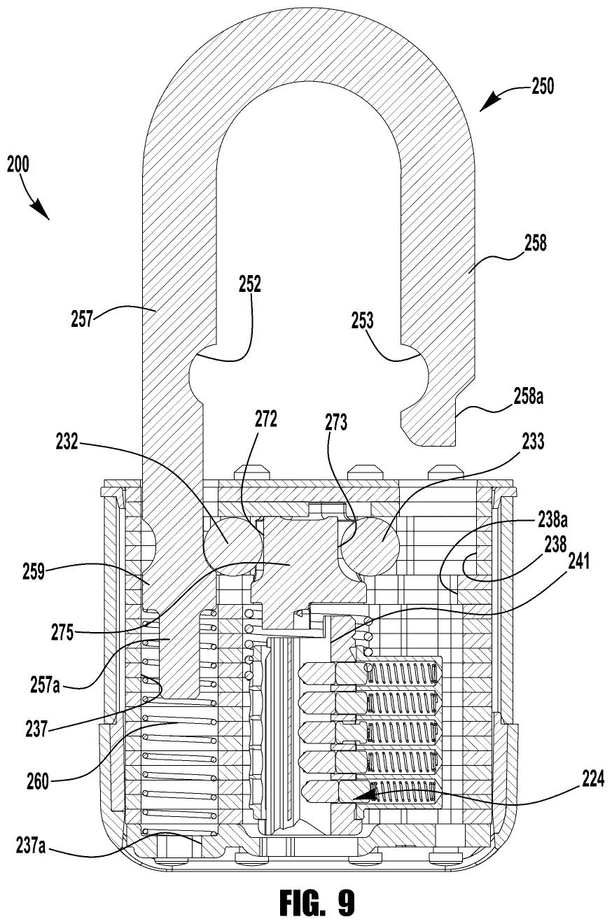

When the key cylinder plug 241 and actuator 270 are rotated to the unlocked position, as shown in FIG. 9, recesses 272, 273 in the blocker portion 275 align with the locking members 232, 233 to allow the locking members to disengage or retract from the shackle notches 252, 253, and the shackle biasing spring 260 below the longer first shackle leg 257 biases the shackle 250 toward a withdrawn, extended, or open position in which the shorter second shackle leg 258 separates from the lock body 220. A base portion 259 of the first shackle leg 257 engages the retracted locking member 232 to prevent removal of the long shackle leg 257 from the lock body 220.

When the shackle 250 is in the open position, the base portion 259 of the first shackle leg 257 holds the corresponding locking member 232 in interlocking engagement with the corresponding actuator recess 272, thus preventing rotation of the actuator 270 back to the locked position. In some key-operated padlocks, the actuator is rotationally fixed with the key cylinder plug. In such embodiments, the key cylinder plug is also held in the locked position, thereby preventing removal of the key from the key cylinder plug when the padlock shackle is open. This arrangement is commonly referred to as a “key retaining” locking arrangement.

To allow a key cylinder plug to be rotated to the locked position for removal of the key while a padlock is in the “shackle open” or unlocked condition, with the actuator being secured in the unlocked position, padlocks with “non-key retaining” locking arrangements provide for a degree of rotatability of the key cylinder plug with respect to the actuator. This rotatability or “lost motion” is often accomplished by providing the key cylinder plug and actuator with interengaging tangs, pins, extensions or other such features, that engage each other for co-rotation of the actuator with the plug from the locked position to the unlocked position, with the plug interengaging feature disengaging from the actuator interengaging feature when the key cylinder plug is rotated back to the locked position. This arrangement is commonly referred to as a “non-key retaining” locking arrangement. In the illustrated embodiment, the key cylinder plug 241 includes a semicircular shaped upper extension that is axially aligned with a corresponding pie piece shaped lower extension of the actuator 270. The upper and lower extensions are sized and shaped to permit a degree of rotation of the key cylinder plug 241 with respect to the actuator 270 that corresponds to the degree of rotation between the unlocked and locked positions of the key cylinder plug 241 (e.g., about 90°). To facilitate re-engagement of the shackle 250 with the locking mechanism when the shackle is forced into the closed position, the actuator 270 may be spring biased to the locked position, for example, by a torsion spring. When the shackle 250 is returned to the closed position, such that the shackle notches 252, 253 are aligned with the locking members 232, 233, a spring-loaded torsional force by the torsion spring on the actuator 270 causes the actuator to rotate toward the locked position, forcing the locking members laterally outward into the shackle notches. This arrangement is shown and described in greater detail in the above incorporated '592 Patent.

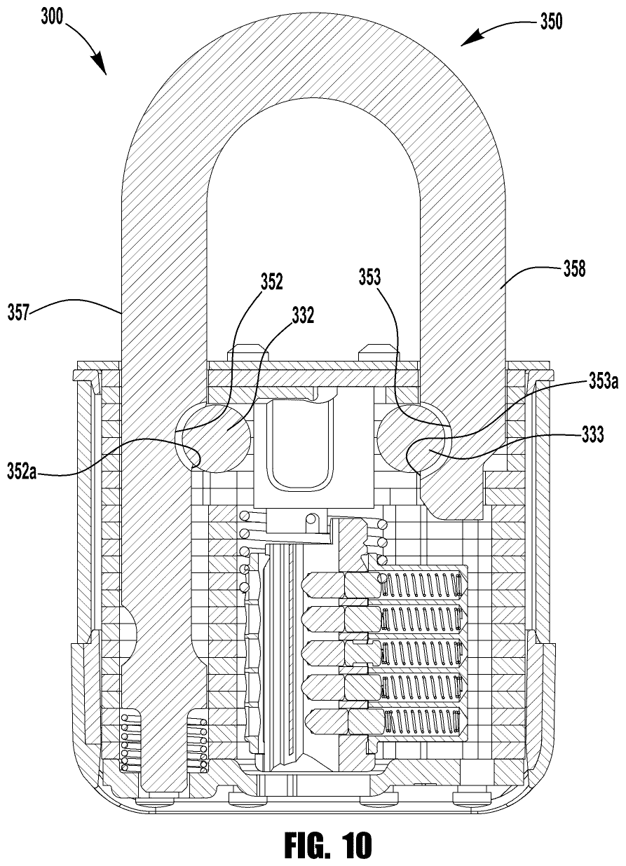

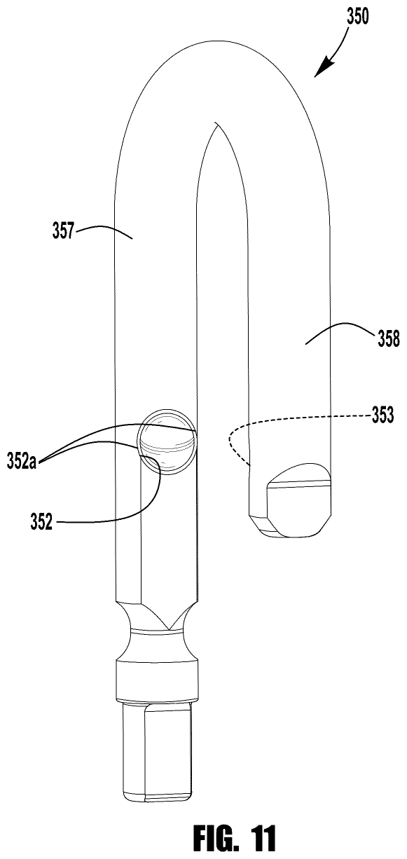

According to another exemplary aspect of the present application, forced twisting rotation of the uncut shackle leg of a cut shackle may additionally or alternatively be limited or prevented by providing locking member engaging shackle notches that are socket-shaped or otherwise contoured to include locking member retaining side wall portions configured to prevent, restrict, or otherwise block rotation of the shackle leg within the shackle bore when the locking member is in locking engagement with the socket-shaped shackle notch, as compared to a conventional shackle leg notch that lacks these blocking side wall portions. FIG. 10 illustrates an exemplary padlock 300 (which may, but need not, be similar in construction to the padlock 200 of FIGS. 6-9) having a shackle 350 with socket-shaped or concave notches 352, 353 including side wall portions 352a, 353a configured to block rotation of the corresponding shackle leg 357, 358 within the corresponding shackle bore 337, 338 when the corresponding locking member 332, 333 is in locking engagement with the shackle notches. While the socket-shaped or concave notches may be provided in a variety of contours, in an exemplary embodiment, the socket-shaped notches may be substantially spherical, for example, for increased surface contact with the spherical locking members. In some embodiments, the contoured fit of the socket-shaped shackle notch around the locking member may limit rotation of the shackle leg within the shackle bore to a range of less than about 26°, or less than about 13° in either direction from the non-twisted orientation, for example to ensure that the shackle leg cannot be rotated enough to provide a gap between the opposed cut portions of the cut shackle leg, thereby preventing removal of the shackle from the hasp or other padlock receiving element of a secured structure.

According to another exemplary aspect of the present application, similar rotational limits for the long shackle leg may be effected to avoid a padlock condition known as “cross-locking,” in which an open, partially withdrawn shackle is rotated into a position in which the short shackle leg is laterally spaced from the padlock body, such that the shackle can be pushed downward into a locked condition (with the lock element engaging the long shackle leg notch), in which the short shackle leg remains disengaged from the lock body. In an exemplary embodiment, a padlock shackle is provided with an axially extending, laterally inward facing concave surface between the long shackle leg notch and the long shackle end groove. The concave surface receives the locking ball when the shackle is in the unlocked, partially withdrawn position, thereby preventing or limiting rotation of the shackle about the long shack leg to a potential cross locking position.

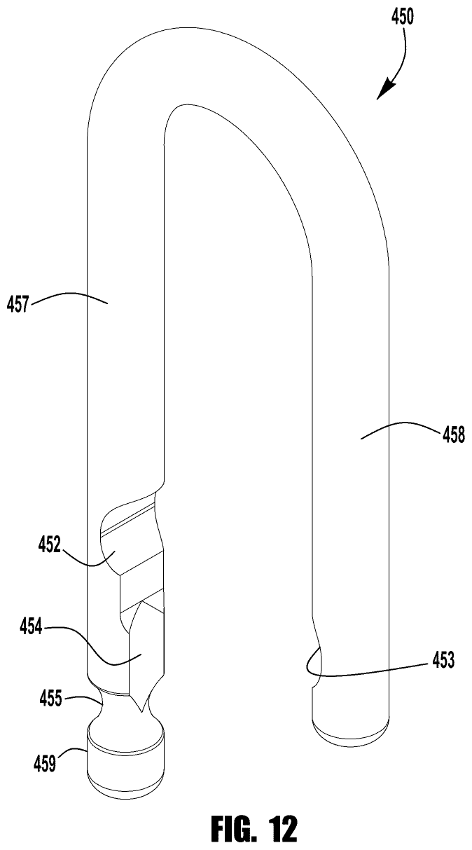

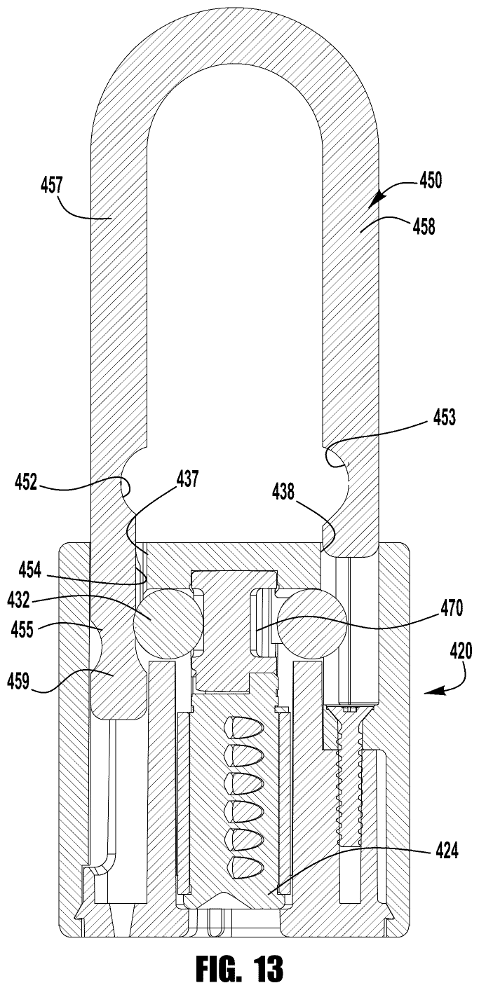

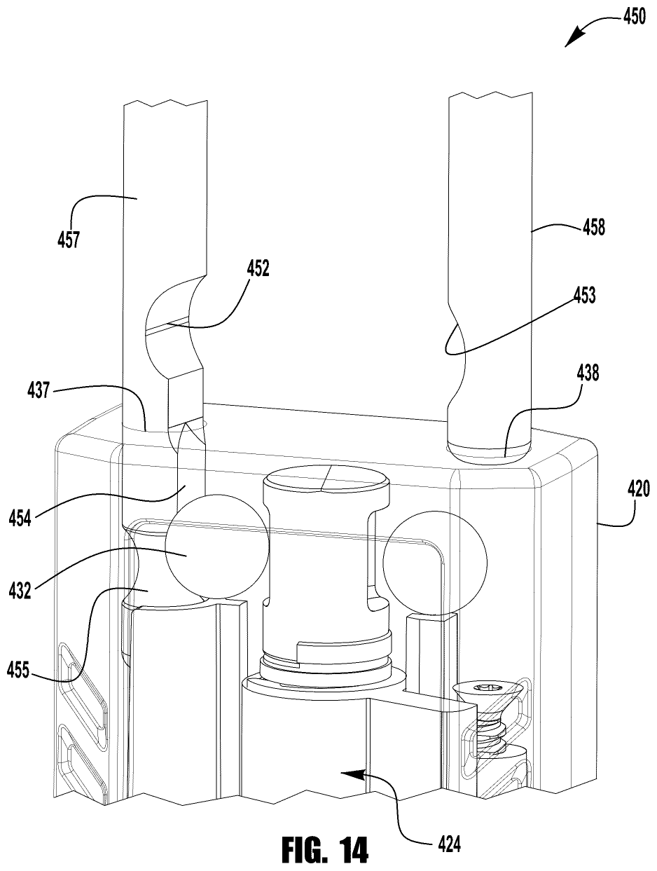

FIG. 12 illustrates an exemplary shackle 450 having a long shackle leg 457 including an axially extending, laterally inward facing concave surface 454 extending between the shackle notch 452 and the shackle end groove 455. As shown in FIGS. 13 and 14, when the padlock 400 is unlocked by rotating key cylinder 424 and actuator 470 to align actuator recesses 472, 473 with the lock balls 432, 433, an axial force applied to the shackle 450 causes the lock balls to retract into the actuator recesses and disengage from the shackle notches 452, 453 to permit withdrawal of the shackle from the lock body 420. When the shackle 450 is in the partially withdrawn position, as shown, the long shackle leg locking ball 432 aligns with and engages the concave surface 454, with this engagement preventing or limiting rotation of the shackle to an orientation in which the short shackle leg 458 laterally separates from the lock body 420. The concave surface 454 may be sized and shaped to limit rotation of the shackle to a range of less than about 10°, less than about 5°, or about 2° to about 4°.

While various aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. A padlock comprising:
a lock body comprising a stack of laminated plates defining first and second shackle bores and a central cavity between the first and second shackle bores;
a shackle having first and second cylindrical shackle legs receivable in the first and second shackle bores of the lock body, the shackle being moveable in an axial direction between a retracted position and an extended position, with at least one of the first and second shackle legs being withdrawn from the lock body in the extended position; and
a locking mechanism disposed in the central cavity of the lock body, the locking mechanism being operable between a locked position securing the shackle in the retracted position and an unlocked position permitting movement of the shackle to the extended position;
wherein the first shackle leg includes a keyed shackle segment and the first shackle bore includes a keyed shackle bore segment defined by at least one plate of the stack of lamination plates, the keyed shackle bore segment being aligned with the keyed shackle segment when the shackle is in the retracted position, wherein the keyed shackle segment and the keyed shackle bore segment are shaped to block rotation of the first shackle leg within the first shackle bore when the shackle is in the retracted position;
wherein the keyed shackle segment includes a post portion disposed at a terminal end of the first shackle leg and extending through a compression spring disposed between the bottom end portion of the lock body and a non-keyed portion of the first shackle leg.

2. The padlock of claim 1, wherein the keyed shackle segment has a non-circular cross-section.

3. The padlock of claim 1, wherein the keyed shackle segment and the keyed shackle bore segment each have complementary shaped semicircular cross-sections.

4. The padlock of claim 1, wherein the keyed shackle bore segment is disposed in a bottom end most plate of the stack of laminated plates.

5. The padlock of claim 4, wherein the keyed shackle bore segment extends through the bottom end portion of the lock body, such that the keyed shackle segment is exposed to an exterior of the lock body when the shackle is in the retracted position.

6. The padlock of claim 1, wherein the locking mechanism comprises a locking member and an actuator rotatable within the central cavity between a locked position and an unlocked position, and including a blocker portion aligned with the first locking member, wherein when the actuator is in the locked position, the blocker portion holds the locking member in locking engagement with a notch in one of the first and second shackle legs, and when the actuator is in the unlocked position, the blocker portion permits the locking member to disengage from the notch.

7. The padlock of claim 6, wherein the notch is disposed in the first shackle leg.

8. The padlock of claim 6, wherein the notch is disposed in the second shackle leg.

9. The padlock of claim 6, wherein the locking member is a first locking member and the notch is a first notch disposed in the first shackle leg, and wherein the locking mechanism further comprises a second locking member, wherein when the actuator is in the locked position, the blocker portion holds the second locking member in locking engagement with a second notch in the second shackle leg, and when the actuator is in the unlocked position, the blocker portion permits the second locking member to disengage from the second notch.

10. The padlock of claim 6, wherein the locking member comprises a locking ball.

11. The padlock of-any claim 6, wherein the notch comprises a laterally inward facing socket including side wall portions configured to block rotation of the first shackle leg within the first shackle bore when the locking member is in locking engagement with the socket.

12. The padlock of claim 1, wherein the first shackle leg has a first length and the second shackle leg has a second length shorter than the first length, such that the second shackle leg is withdrawn from the lock body in the extended position.

13. The padlock of claim 1, wherein the second shackle leg includes a keyed shackle segment and the second shackle bore includes a keyed shackle bore segment that is aligned with the keyed shackle segment of the second shackle leg when the shackle is in the retracted position, wherein the keyed shackle segment of the second shackle leg and the keyed shackle bore segment of the second shackle bore are shaped to block rotation of the second shackle leg within the second shackle bore when the shackle is in the retracted position.

14. The padlock of claim 1, wherein the keyed shackle segment and the keyed shackle bore segment are shaped to limit rotation of the first shackle leg within the first shackle bore to a range of less than about 26°.

15. A padlock comprising:
a lock body comprising a stack of laminated plates defining first and second shackle bores and a central cavity between the first and second shackle bores;
a shackle having first and second cylindrical shackle legs receivable in the first and second shackle bores of the lock body, the shackle being moveable in an axial direction between a retracted position and an extended position, with at least one of the first and second shackle legs being withdrawn from the lock body in the extended position; and
a locking mechanism disposed in the central cavity of the lock body, the locking mechanism being operable between a locked position securing the shackle in the retracted position and an unlocked position permitting movement of the shackle to the extended position;
wherein the first shackle leg includes a keyed shackle segment and the first shackle bore includes a keyed shackle bore segment defined by at least one plate of the stack of lamination plates, the keyed shackle bore segment being aligned with the keyed shackle segment when the shackle is in the retracted position, wherein the keyed shackle segment and the keyed shackle bore segment are shaped to block rotation of the first shackle leg within the first shackle bore when the shackle is in the retracted position; and
wherein the keyed shackle segment includes a rib portion extending radially outward from a cylindrical portion of the first shackle leg.

16. The padlock of claim 15, wherein the keyed shackle bore segment is disposed in a bottom end most plate of the stack of laminated plates.

17. The padlock of claim 15, wherein the keyed shackle bore segment extends through the bottom end portion of the lock body, such that the keyed shackle segment is exposed to an exterior of the lock body when the shackle is in the retracted position.

18.-32. (canceled)

33. A padlock comprising:
a lock body;
a shackle having first and second shackle legs receivable in corresponding first and second shackle bores in the lock body, the shackle being moveable in an axial direction between a retracted position and an extended position, with the second shackle leg being withdrawn from the lock body in the extended position; and
a locking mechanism disposed in a central cavity of the lock body, the locking mechanism comprising:
a first locking member; and
an actuator rotatable within the central cavity between a locked position and an unlocked position, and including a blocker portion aligned with the first locking member, wherein when the actuator is in the locked position, the blocker portion holds the first locking member in locking engagement with a laterally inward facing notch in the first shackle leg, and when the actuator is in the unlocked position, the blocker portion permits the first locking member to disengage from the first shackle leg notch;
wherein when the shackle is in a partially withdrawn position between the retracted position and the extended position, the first locking member is aligned and engaged with an axially extending, laterally inward facing concave surface of the first shackle leg.

34. The padlock of claim 33, wherein the axially extending, laterally inward facing concave surface of the first shackle leg is sized and shaped to limit rotation of the shackle to a range of less than about 10° when the shackle is in the partially withdrawn position.
